(19) United States
(12) Patent Application Publication
(10) Pub. No.: US 2017/0046700 A1
(43) Pub. Date: Feb. 16, 2017

(54) ANOMALY DETECTION AND USER-CONTEXT DRIVEN AUTHORIZATION REQUEST FOR AUTOMATIC PAYMENTS THROUGH MOBILE DEVICES

(71) Applicant: CA, Inc., New York, NY (US)

(72) Inventors: VIKRANT NANDAKUMAR, Bangalore (IN); Naveen Harry Michael, Bangalore (IN); Hemanth Kumar Pinninti, Vizianagaram (IN)

(73) Assignee: CA, Inc., New York, NY (US)

(21) Appl. No.: 14/822,319

(22) Filed: Aug. 10, 2015

(51) Int. Cl. G06Q 20/40; H04W 4/02; G06Q 20/32; H04W 12/06

(52) U.S. Cl. CPC G06Q 20/405; H04W 12/06; H04W 4/02; G06Q 20/3226; G06Q 20/3224

(57) ABSTRACT

A method includes performing operations as follows on a processor; providing an event anomaly rule that defines a condition for requiring authorization for processing the event, receiving an event notification for a user from a first data processing system, receiving an availability notification from a mobile device associated with the user, and sending the event notification to the mobile device associated with the user when the event satisfies the condition of the event anomaly rule at a time based on the availability notification.

### BACKGROUND

The present disclosure relates to computing systems, and, in particular, to methods, systems, and computer program products for handling anomalies in an automatic payment system.

As payments technology evolves, new types of payment systems and techniques are being used to provide convenience as well as increased protection against counterfeit, account misuse, and other types of fraud. Automatic payment systems may be used to avoid late payment fees and to relieve a payor of the burden of remembering bill due dates, amounts, etc. and making a manual payment. Automatic payment systems may be susceptible to errors in various situations, however. For example, an automatic payment system may be programmed to pay a standard amount for a particular merchant. But the standard amount may be a discounted amount and the payor may be accidentally charged a full amount during a particular billing period. When the automatic payment system fails to pay the full amount the payor is charged, a subsequent bill may include a late fee and/or finance charge. As a result, the payor may need to contact the merchant to resolve the discrepancies in the amount charged and amount paid during one or more billing cycles and may need to perform a manual payment. Automatic payment systems are also typically not capable of taking into consideration problems with the account or instrument used to make a payment, such as when an account has insufficient funds to make a payment, when an account has been closed or suspended, and/or when financial card/account is active, expired, or closed.

### SUMMARY

In some embodiments of the inventive subject matter, a method comprises performing operations as follows on a processor: providing an event anomaly rule that defines a condition for requiring authorization for processing the event, receiving an event notification for a user from a first data processing system, receiving an availability notification from a mobile device associated with the user, and sending the event notification to the mobile device associated with the user when the event satisfies the condition of the event anomaly rule at a time based on the availability notification.

In other embodiments of the inventive subject matter, a method comprises performing operations as follows on a processor: generating an availability notification associated with a user, sending the availability notification to a data processing system, and receiving an event notification for the user from the data processing system responsive to sending the availability notification. The event satisfies a condition for requiring authorization for processing the event in an event anomaly rule

In further embodiments of the inventive subject matter, a system comprises a processor and a memory coupled to the processor, which comprises computer readable program code embodied in the memory that when executed by the processor causes the processor to perform operations comprising; providing an event anomaly rule that defines a condition for requiring authorization for processing the event, receiving an event notification for a user from a first data processing system, receiving an availability notification from a mobile device associated with the user, and sending the event notification to the mobile device associated with the user when the event satisfies the condition of the event anomaly rule at a time based on the availability notification.

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. It is further intended that all embodiments disclosed herein can be implemented separately or combined in any way and/or combination.

### BRIEF DESCRIPTION OF TEE DRAWINGS

Other features of embodiments will be more readily understood from the following detailed description of specific embodiments thereof when read in conjunction with the accompanying drawings, in which:

FIG. 1 is a block diagram of a system for facilitating user-context driven authorizations for automatic bill payments in accordance with some embodiments of the inventive subject matter;

FIG. 2 illustrates a data processing system that may be used to implement the automatic payment system of FIG. 1 in accordance with some embodiments of the inventive subject matter;

FIG. 3 is a block diagram that illustrates a software/hardware architecture for facilitating user-context driven authorizations for automatic bill payments in accordance with some embodiments of the present inventive subject matter;

FIG. 4 is a block diagram that illustrates a mobile device/terminal in accordance with some embodiments of the present inventive subject matter; and

FIGS. 5-7 are flowcharts that illustrate operations for facilitating user-context driven authorizations for automatic bill payments in accordance with some embodiments of the inventive subject matter.

### DETAILED DESCRIPTION

In the following detailed description, numerous specific details are set forth to provide a thorough understanding of embodiments of the present disclosure. However, it will be understood by those skilled in the art that the present invention may be practiced without these specific details. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto That is, all embodiments and/or features of any embodiments can be combined in any way and/or combination,

As used herein, a “service” includes, but is not limited to, a software and/or hardware service, such as cloud services in which software, platforms, and infrastructure are provided remotely through, for example, the Internet. A service may be provided using Software as a Service (SaaS), Platform as a Service (PaaS), and/or Infrastructure as a Service (IaaS) delivery models. In the SaaS model, customers generally access software residing in the cloud using a thin client, such as a browser, for example. In the PaaS model, the customer typically creates and deploys the software in the cloud sometimes using tools, libraries, and routines provided through the cloud service provider. The cloud service provider may provide the network, servers, storage, and other tools used to host the customer's application(s). In the IaaS model, the cloud service provider provides physical and/or virtual machines along with hypervisor(s). The customer installs operating system images along with application software on the physical and/or virtual infrastructure provided by the cloud service provider.

As used herein, the term “data processing facility” includes, but it not limited to, a hardware element, firmware component, and/or software component. A data processing system may be configured with one or more data processing facilities.

As used herein, the term “mobile terminal” or “mobile device” may include a satellite or cellular radiotelephone with or without a multi-line display; a Personal Communications System (PCS) terminal that may combine a cellular radiotelephone with data processing, facsimile and data communications capabilities; a PDA or smart phone that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals or mobile devices may also be referred to as “pervasive computing” devices,

As used herein, a “bill” or “invoice” means a request for payment for something that has been previously purchased. For example, a person may purchase an item at a store on credit and the credit card company will subsequently bill the person for the item previously purchased. Another example is a person may join a club that has monthly membership dues. Each month the club may bill the person for the dues that are owed to continue membership in the club. These examples are for purposes of illustrating embodiments of the inventive subject matter and are not exhaustive.

Some embodiments of the inventive subject matter are described herein in the context of an automatic payment system providing anomalous bills or invoices to a user at a mobile device for authorization before the automatic payment system proceeds with payment of the bill. It will be understood that embodiments of the inventive subject matter can be used to detect anomalous events in general that require user authorization for further processing.

Some embodiments of the inventive subject matter stern from a realization that automatic payment systems work best for paying bill and invoices when the bills and invoices are predictable and when the payor's account used to pay a bill is in good standing with sufficient funds to pay the bills that have been issued. When anomalies occur that cause a bill to deviate from a predicted amount, such as discounts, surcharges, late fees, and the like, an automatic payment system may not generate a payment in the proper amount resulting in an overpayment or underpayment, which may result in penalties, surcharges, finance charges, or the like. An automatic payment system, according to some embodiments of the inventive subject matter, may detect anomalies in a bill based on one or more rules that can be defined by a user. When an anomalous bill has been detected, the bill can be sent to the user for authorization before the automatic payment system initiates payment of the bill. The user can create rules that require any bill over a certain sum to be considered anomalous to allow the user to ensure that the financial account or instrument being used to pay the bill has sufficient funds or credit available. For improved security, the automatic payment system may send a bill that has been identified as being anomalous based on the one or more rules to the user for authorization at a time that is based on an availability notification received from the user. This may reduce the time in which the automatic payment system waits for a bill payment authorization from the user and also reduce the frequency in which the automatic payment system times out waiting for a bill authorization response from a user.

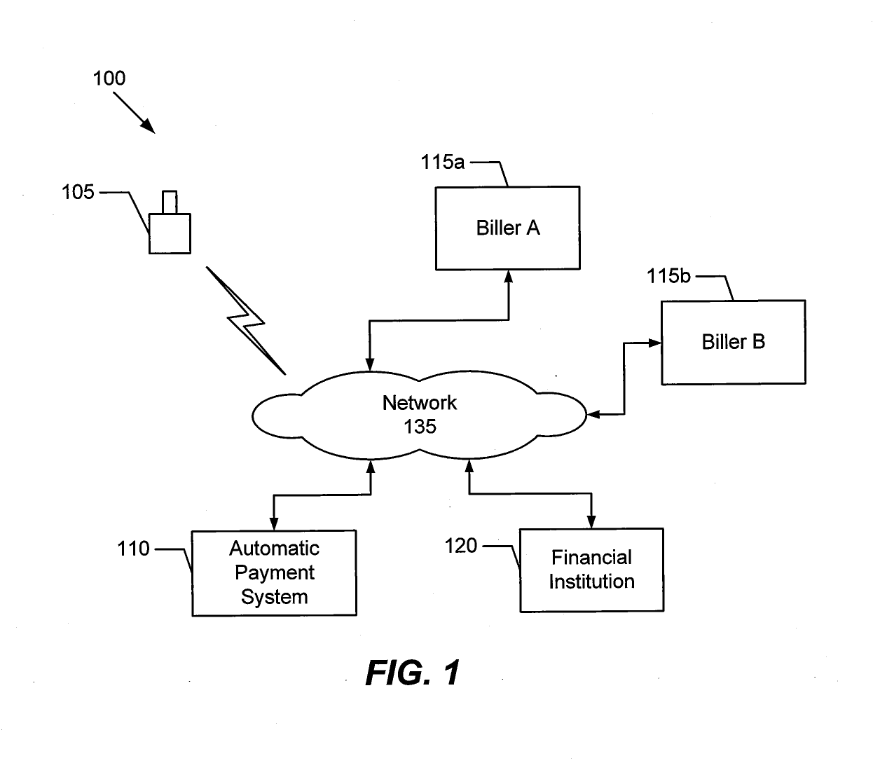

FIG. 1 is a block diagram of a system for facilitating user-context driven authorizations for automatic bill payments in accordance with some embodiments of the inventive subject matter. The system 100 comprises an automatic payment system 110 that may be configured to automatically pay bills and invoices for a user of a mobile device 105. For example, the automatic payment system 110 may be presented with bills for the user from one or more billers represented as biller A 115a and biller B 115b. The billers 115a and 115b may be merchants, service providers, creditors, or any other type of entity that electronically bills or invoices the user. The user may be registered with the automatic payment system 110 to automatically pay bills and invoices from the one or more bitters 115a, 115b that the user has approved. The user may also register one or more accounts on the automatic payment system 110 to be used for paying the bills and invoices generated by the biller(s) 11.5a, 115b. These accounts may include, but are not limited to, a checking account, a savings account, a credit card, a debit card, a merchant charge card, a gift card, a rewards program account, and the like. The automatic payment system 110 may authorize the financial institution 120 or other payment entity that supports the account to be used for paying a particular bill or invoice to make the payment to the appropriate biller 115a, 115b. As described above, when anomalies occur that cause a bill to deviate from a predicted amount, traditional automatic payment systems may not generate a payment in the proper amount resulting in an overpayment or underpayment, which may result in penalties, surcharges, finance charges, or the like. The automatic payment system 110 may be configured to detect such anomalous bills or invoices and send the bill or invoice to the mobile terminal 105 to allow the user to review and authorize payment or, for example, to request the biller 115a, 115b to send a corrected bill, to use a different account for payment in this instance, or to simply not pay the bill to contest the charges. For improved security, the automatic payment system may send the bill at a time that is based on an availability notification received from the user. The automatic payment system 110 may be more susceptible to attack by hostile entities when in a waiting state for authorization of a payment. By sending the bill or invoice to the user when the user is more likely to respond, the time spent waiting for a bill payment authorization may be reduced and the frequency in which the automatic payment system times out waiting for a bill authorization response from a user may also be reduced.

The mobile device 105, automatic payment system 110, biller A 115a, biller B 115b, and the financial institution 120 may communicate over the network 135. The network 135 may include wireless and/or wireline connections and may be direct or include one or more intervening local area networks, wide area networks, and/or the Internet. The network 135 may be a global network, such as the Internet or other publicly accessible network. Various elements of the network 135 may be interconnected by a wide area network, a local area network, an Intranet, and/or other private network, which may not be accessible by the general public. Thus, the network 135 may represent a combination of public and private networks or a virtual private network (VPN). The network 135 may be a wireless network, a wireline network, or may be a combination of both wireless and wireline networks.

Although FIG. 1 illustrates a system for facilitating user-context driven authorizations for automatic bill payments in accordance with some embodiments of the inventive subject matter it will be understood that embodiments of the present invention are not limited to such configurations, but are intended to encompass any configuration capable of carrying out the operations described herein.

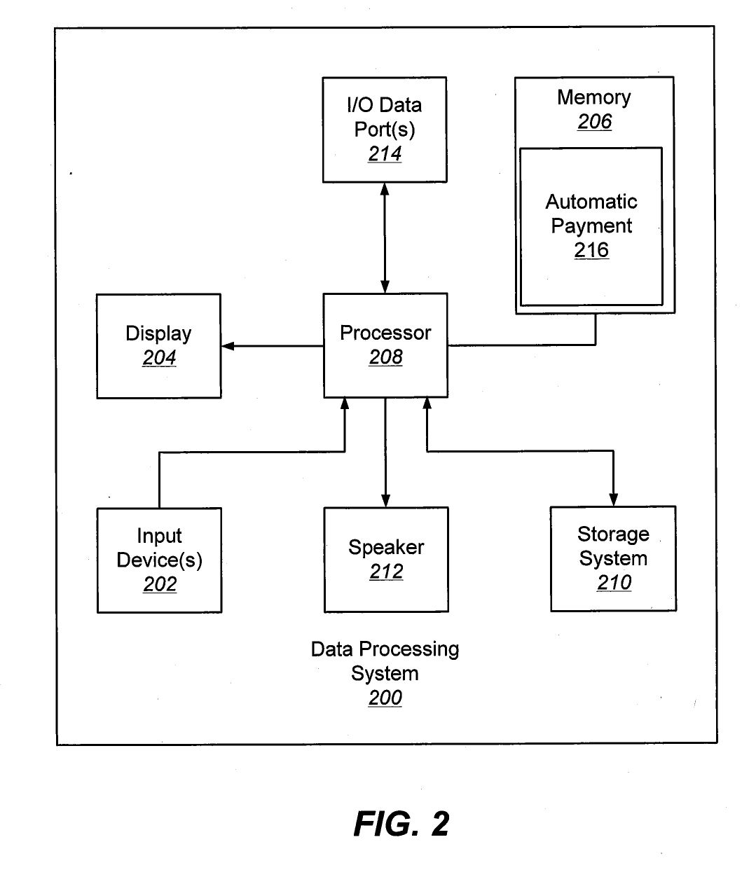

Referring now to FIG. 2, a data processing system 200 that may be used to implement the automatic payment system 110 of FIG. 1, in accordance with some embodiments of the inventive subject matter, comprises input device(s) 202, such as a keyboard or keypad, a display 204, and a memory 206 that communicate with a processor 208. The data processing system 200 may further include a storage system 210, a speaker 212, and an input/output (I/O) data port(s) 214 that also communicate with the processor 208. The storage system 210 may include removable and/or fixed media, such as floppy disks, ZIP drives, hard disks, or the like, as well as virtual storage, such as a RAMDISK. The I/O data port(s) 214 may be used to transfer information between the data processing system 200 and another computer system or a network (e.g., the Internet). These components may be conventional components, such as those used in many conventional computing devices, and their functionality, with respect to conventional operations, is generally known to those skilled in the art. The memory 206 may be configured with an automatic payment module 216 that may provide functionality that may include, but is not limited to, detecting anomalies in a user bill or invoice and notifying the user of the anomalous bill at a time that is based on availability information received from the user.

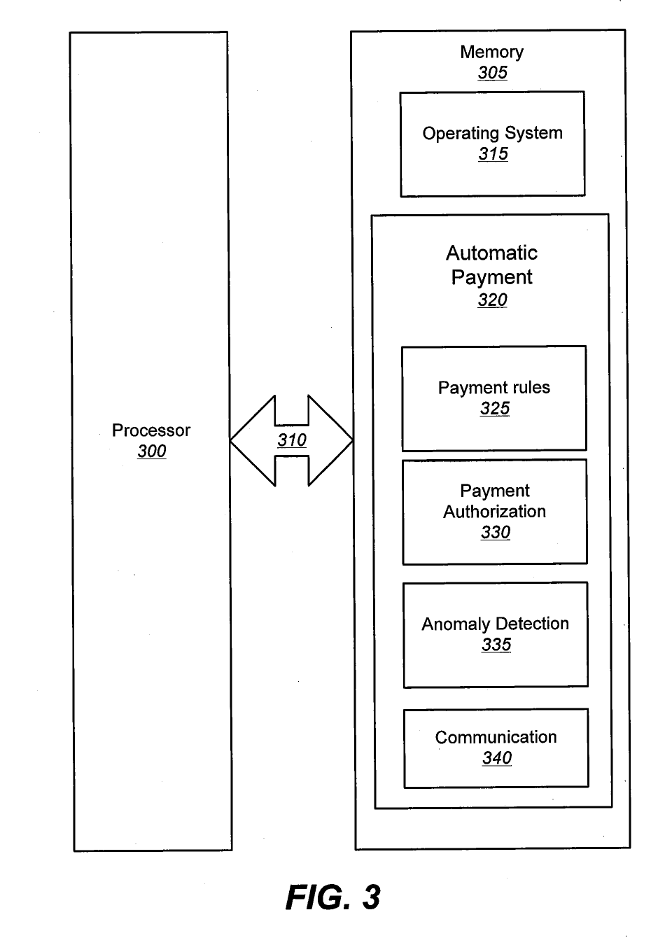

FIG. 3 illustrates a processor 300 and memory 305 that may be used in embodiments of data processing systems, such as the automatic payment system 110 of FIG. 1 and the data processing system 200 of FIG. 2, respectively, for facilitating user-context driven authorizations for automatic bill payments in accordance with some embodiments of the inventive subject matter. The processor 300 communicates with the memory 305 via an address/data bus 310. The processor 300 may be, for example, a commercially available or custom microprocessor. The memory 305 is representative of the one or more memory devices containing the software and data used for facilitating user-context driven authorizations for automatic bill payments in accordance with some embodiments of the inventive subject matter. The memory 305 may include, but is not limited to, the following types of devices cache, ROM, PROM, EPROM, EEPROM, flash, SRAM, and DRAM.

As shown in FIG. 3, the memory 305 may contain two or more categories of software and/or data: an operating system 315 and an automatic payment module 320. In particular, the operating system 315 may manage the data processing system's software and/or hardware resources and may coordinate execution of programs by the processor 300.

The automatic payment module 320 may comprise a payment rules module 325, a payment authorization module 330, an anomaly detection module 335, and a communication module 340. The payment rules module 325 may be configured to define one or more rules that can be used to identify anomalies in bills or invoices. In some embodiments the payment rules module 325 may include a user interface through which a user may create one or more rules that may apply, for example, to bills from particular billing entities, bills in particular categories, and/or all bills. The rules may contain one or more conditions that when satisfied require the automatic payment system 110 to obtain authorization from the user before initiating payment of the bill. Some example payment rules are set forth below:

A) Check for a payment due having a description that contains any of the words “FEE, LATE PAYMENT.”

B) Check for a payment due having a description that contains any of the following words: “MEMBERSHIP FEE” with a value greater than $25.

C) Check for a payment due having a value greater than $200.

D) Check for a payment due in which payment is required between November 15 and January 30.

The payment authorization module 330 may be configured to communicate with one or more financial institutions 120, billers 115a, 115b, or other entities to receive bills or invoices therefrom and to initiate payment for those bills. For example, the payment authorization module 330 may communicate with a financial institution 120 or other entity (e.g., a merchant supporting a charge account) to initiate payment for a particular bill via an account and/or financial instrument specified by a user.

The anomaly detection module 335 may be configured to apply the anomaly rules generated and provided through the payment rules module 325 to incoming bills and invoices for a user. When a bill or invoice satisfies one or more condition(s) specified in one or more of the rules, the anomaly detection module 335 places the bill or invoice in a notification queue for the user. The anomaly detection module 335 may also be configured to receive an availability notification from the user via the user's mobile device 105 that is indicative of a time when the user may be more likely to respond to a bill payment authorization request. The bill or invoice may then be sent from the notification queue to the user's mobile device 105 for payment authorization at a time based on the availability notification.

The communication module 340 may be configured to facilitate communication between the automatic payment system 130 and other entities, such as the billers 115a, 115b, the financial institution 120, and the user's mobile device 105.

Although FIG. 3 illustrates hardware/software architectures that may be used in data processing systems, such as the automatic payment system 110 and the data processing system 200 of FIG. 2 for facilitating user-context driven authorizations for automatic bill payments in accordance with some embodiments of the inventive subject matter, it will be understood that the present invention is not limited to such a configuration but is intended to encompass any configuration capable of carrying out operations described herein.

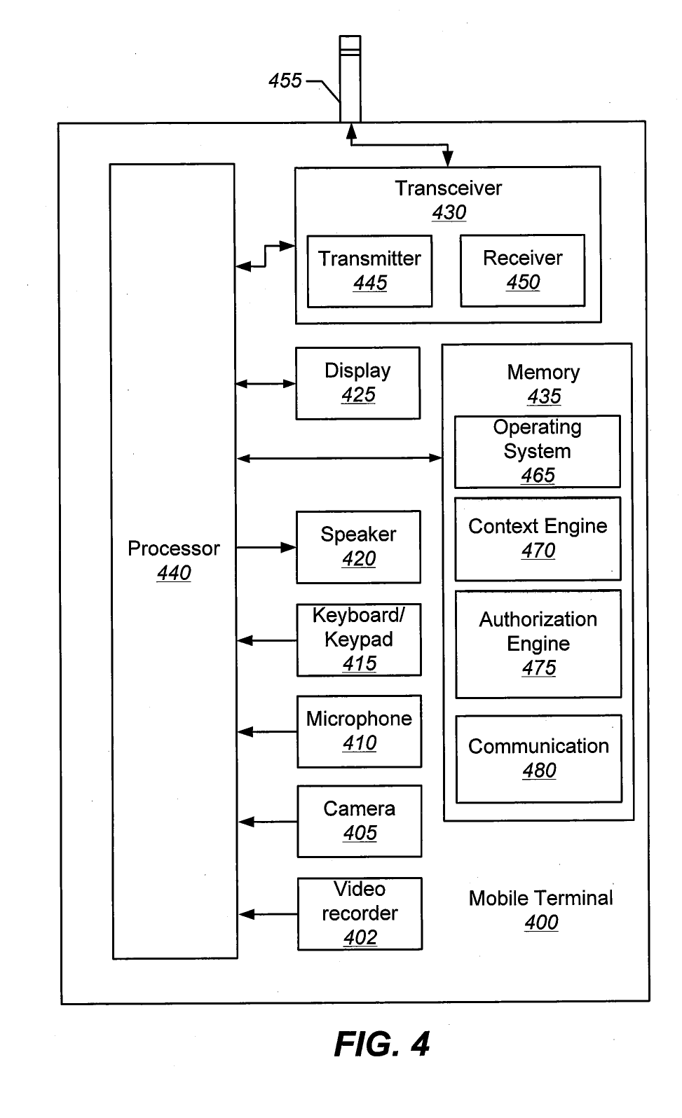

Referring now to FIG. 4, an exemplary mobile terminal 400 that may be used to implement the mobile device 105 of FIG. 1, in accordance with some embodiments of the inventive subject matter, includes a video recorder 402, a camera 405, a microphone 410, a keyboard/keypad 415, a speaker 420, a display 425, a transceiver 430, and a memory 435 that communicate with a processor 440. The transceiver 430 comprises a transmitter circuit 445 and a receiver circuit 450, which respectively transmit outgoing radio frequency signals to base station transceivers and receive incoming radio frequency signals from the base station transceivers via an antenna 455. The radio frequency signals transmitted between the mobile terminal 400 and the base station transceivers may comprise both traffic and control signals (e.g., paging signals/messages for incoming calls), which are used to establish and maintain communication with another party or destination. The radio frequency signals may also comprise packet data information, such as, for example, cellular digital packet data (CDPD) information. The foregoing components of the mobile terminal 400 may be included in many conventional mobile terminals and their functionality is generally known to those skilled in the art.

The processor 440 communicates with the memory 435 via an address/data bus. The processor 440 may be, for example, a commercially available or custom microprocessor. The memory 435 is representative of the one or more memory devices containing the software and data used to facilitate user-context driven authorizations for automatic bill payment in accordance with some embodiments of the present invention. The memory 435 may include, but is not limited to, the following types of devices: cache, ROM, PROM, EPROM, EEPROM, flash, SRAM, and DRAM.

As shown in FIG, 4, the memory 435 may contain up to four or more categories of software and/or data: the operating system 465, a context engine module 470, an authorization engine module 475, and a communication module 480. The operating system 465 generally controls the operation of the mobile terminal 400. In particular, the operating system 465 may manage the mobile terminal's software and/or hardware resources and may coordinate execution of programs by the processor 440. The context engine module 470 may analyze factors that may include, but are not limited to, cellular interface usage, Wi-Fi interface usage, Bluetooth interface usage, wireless local area network (WLAN) interface usage, geographic location, and/or operation history in assessing the current availability of the user and the likelihood that the user may be available to authorize a bill payment request. Based on one or more of these factors, the context engine may send an availability notification to the automatic payment system 110, which the automatic payment system 110 uses to determine when to send bills that need authorization for payment to the mobile terminal 105 for authorization by the user.

The authorization engine 475 may be configured to receive the bills requiring authorization for payment from the automatic payment system 110. In accordance with various embodiments of the inventive subject matter, the user may review and authorize payment of the bill by sending a payment authorization to the automatic payment processing system 110 or, for example, may request the biller 115a, 115b to send a corrected bill, may use a different account for payment in this instance, or may choose to not pay the bill to contest the charges. As part of reviewing and authorizing payment for a received bill, the authorization engine may authenticate the user's identity using, for example, a passcode and/or biometric authentication. The biometric information may be any type of information that can be used to uniquely recognize a human based on one or more intrinsic physical or behavioral traits. Such traits may include, but are not limited to, fingerprint, face recognition, DNA, hand and palm geometry, iris recognition, retina recognition, odor/scent, typing rhythm, gait, and voice frequency, loudness, cadence, and/or pattern.

The communication module 480 may be configured to facilitate communication between the mobile device 105 and the automatic payment system 110 to facilitate user-context driven authorizations for automatic bill payments in accordance with some embodiments of the inventive subject matter. The communication module 480 may also facilitate communication with other entities, such as the billers 115a, 115b to enroll in electronic billing and/or the financial institution 120 or other types or merchants to setup savings, checking, and/or credit accounts.

Although FIG. 4 illustrates an exemplary software and hardware architecture that may be used to provide a mobile terminal that can facilitate user-context driven authorizations for automatic bill payments in accordance with some embodiments of the inventive subject matter, it will be understood that embodiments of the present invention are not limited to such a configuration, but are intended to encompass any configuration capable of carrying out the operations described herein.

Computer program code for carrying out operations of data processing systems discussed above with respect to FIGS. 1-4 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the mobile device 105 of FIG. 1, the automatic payment system 110 of FIG. 1, the data processing system 200 of FIG. 2, the hardware/software architecture of FIG. 3, and the mobile terminal of FIG, 4 may each be implemented as a single processor system, a multi-processor system, a multi-core processor system, or even a network of stand-alone computer systems, in accordance with various embodiments of the inventive subject matter. Each of these processor/computer systems may be referred to as a “processor” or “data processing system.”

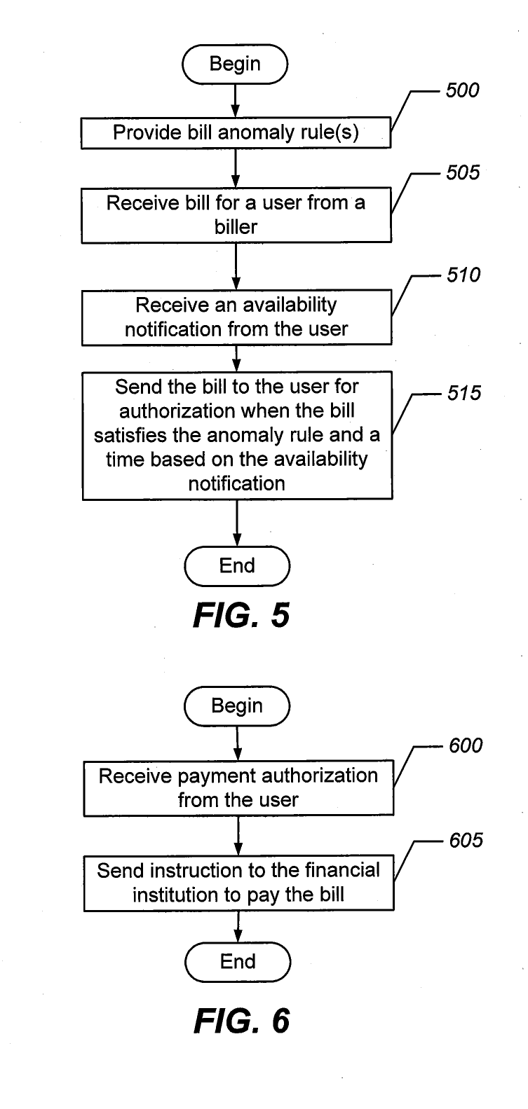

The data processing apparatus of FIGS. 1-4 may be used to determine how to facilitate user-context driven authorizations for automatic bill payments according to various embodiments described herein. These apparatus may be embodied as one or more enterprise, application, personal, pervasive and/or embedded computer systems and/or apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memory 206 coupled to the processor 208, the memory 305 coupled to the processor 300, and the memory 435 coupled to the processor 440 include computer readable program code that, when executed by the respective processors, causes the respective processors to perform operations including one or more of the operations described herein with respect to FIGS. 5-7.

FIGS. 5-7 are flowcharts that illustrate operations for facilitating user-context driven authorizations for automatic bill payments in accordance with some embodiments of the inventive subject matter. Referring now to FIG. 5, operations begin at block 500 where the automatic payment system 110 provides one or more bill anomaly rules that, in some embodiments, may be created through input from the user (i.e., bill payor). The automatic payment system 110 receives one or more bills for the user from a biller 115a, 115b at block 505. A determination may be made whether the bill satisfies one or more condition(s) specified in one or more of the bill anomaly rules. An availability notification may be received from the user at block 510, which provides an indication of when the user may be more likely to review and authorize payment (or take other action) for a bill. The automatic payment system sends the bill to the user at, for example, the mobile device 105 for review and authorization at block 515 when the bill satisfies one or more of the conditions specified in one or more of the bill anomaly rules and at a time based on the availability notification received from the user.

Referring now to FIG, 6, the user upon receiving the bill that has been identified as anomalous based on the defines bill anomaly rules may send a payment authorization, which is received by the automatic payment system 110 at block 600. The automatic payment system 110 may send an instruction to the financial institution 120 to pay the bill at block 605. The financial institution 120 is representative of any entity that is associated with the account or financial instrument used to pay the bill. For security purposes, the automatic payment system 110 may set a timer after sending the bill to the user for payment authorization. The automatic payment system 110 may only send instructions to the financial institution 120 to pay the bill when the payment authorization is received from the user before expiration of the timer. Because the automatic payment system 110 takes into account the user's context based on the availability notification received from the user, the frequency in which the automatic payment system 110 times out waiting for the user to respond with a payment authorization may be reduced.

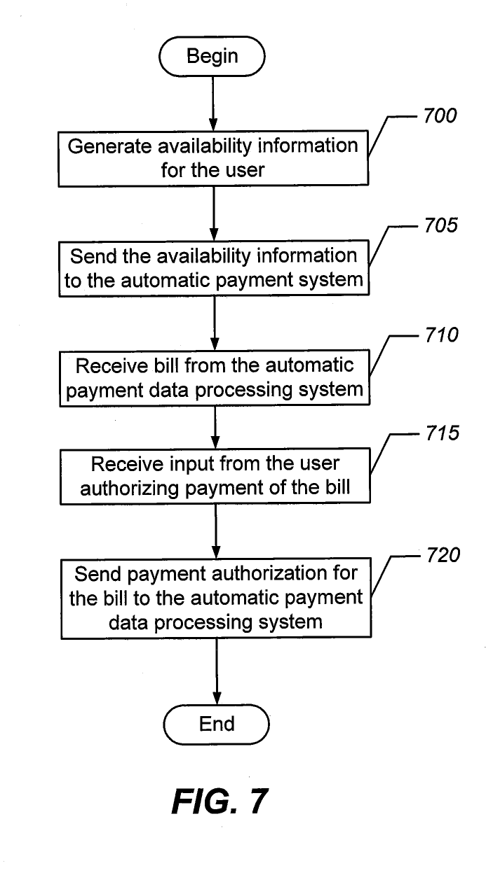

Referring now to FIG. 7, operations of a mobile device, such as mobile device 105/400, begin at block 700 where the context engine 470 analyzes one or more factors, such as cellular interface usage, Wi-Fi interface usage, Bluetooth interface usage, WLAN interface usage, geographic location, and/or operation history in assessing the current availability of the user and the likelihood that the user may be available to authorize a bill payment request. Based on one or more of these factors, the context engine sends an availability notification to the automatic payment system 110 at block 705. At block 710, a bill is received from the automatic payment data processing system that has been determined to be anomalous based on the bill anomaly rules that have been defined, i.e., the bill satisfies one or more conditions in one or more of the defined rules. At block 715, the user may provide input authorizing payment of the bill (or taking some type of alternative action, such as contacting the biller 115a, 115b to request an alternative bill or not pay the bill if the user wishes to contest the charge). The user may be required to complete an authentication process to verify the user's identity for security purposes. As described above, the authentication process may be based on a passcode and/or biometric factors. The payment authorization may be send to the automatic payment system 110 at block 720

Some embodiments of the inventive subject matter may provide an automatic payment system that can be used to handle anomalous bills that deviate from predicted or expected characteristics so that a user may review the anomaly before a potentially errant payment is sent. Moreover, sending the anomalous bill to the user for review and authorization may be performed based the user-context to reduce the risk that the user is unavailable to review the bill, which may provide increased security as the automatic payment system may be at higher risk for attack by hostile entities when in a state waiting for payment authorization.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method comprising:
performing operations as follows on a processor:
providing an event anomaly rule that defines a condition for requiring authorization for processing the event;
receiving an event notification for a user from a first data processing system;
receiving an availability notification from a mobile device associated with the user; and
sending the event notification to the mobile device associated with the user when the event satisfies the condition of the event anomaly rule at a time based on the availability notification.

2. The method of claim 1, further comprising:
receiving a processing authorization for the event from the mobile device associated with the user responsive to sending the event notification to the mobile device associated with the user; and
sending an instruction to a second data processing system associated with the user to process the event.

3. The method of claim 2, further comprising:
setting a timer responsive to sending the event notification to the mobile device associated with the user; and
wherein sending the instruction to the second data processing system comprises sending the instruction to the second data processing system when the processing authorization is received prior to expiration of the timer.

4. The method of claim 1, wherein the condition of the event anomaly rule is based on one of a date, a transaction description, and a monetary amount.

5. The method of claim 1, wherein the availability notification from the mobile device is based on use of a cellular interface on the mobile device, use of a Wi-Fi interface on the mobile device, use of a Bluetooth interface on the mobile device, and/or use of a wireless local area network (WLAN) interface on the mobile device.

6. The method of claim 1, wherein the availability notification from the mobile device is based on one of a geographic location of the mobile device and a history of operations performed on the mobile device.

7. The method of claim 1, wherein providing the event anomaly rule comprises providing the event anomaly rule based on input received from the user.

8. The method of claim 1, wherein providing the event anomaly rule comprises providing a plurality of event anomaly rules that define a plurality of conditions, respectively, for requiring authorization for processing the event; and
wherein sending the event notification to the mobile device associated with the user comprises sending the event notification to the mobile device associated with the user for authorization to process the event when the event satisfies one of the plurality of conditions.

9. A method, comprising:
performing operations as follows on a processor on a mobile device:
generating an availability notification associated with a user;
sending the availability notification to a data processing system; and
receiving an event notification for the user from the data processing system responsive to sending the availability notification;
wherein the event satisfies a condition for requiring authorization for processing the event in an event anomaly rule.

10. The method of claim 9, further comprising:
receiving input from the user authorizing processing of the event;
sending an authorization for processing the event to the data processing system.

11. The method of claim 10, wherein receiving input from the user authorizing processing of the event comprises:
receiving information from the user authenticating an identity of the user.

12. The method of claim 11, wherein the information authenticating the identity of the user comprises one of a passcode and biometric information.

13. The method of claim 9, wherein the condition of the event anomaly rule is based on a date, a transaction description, and/or a monetary amount.

14. The method of claim 9, wherein the availability notification is based on use of a cellular interface on the mobile device, use of a Wi-Fi interface on the mobile device, use of a Bluetooth interface on the mobile device, and/or use of a wireless local area network (WLAN) interface on the mobile device.

15. The method of claim 9, wherein the availability notification is based on a geographic location of the mobile device and/or a history of operations performed on the mobile device.

16. A system, comprising:
a processor; and
a memory coupled to the processor and comprising computer readable program code embodied in the memory that when executed by the processor causes the processor to perform operations comprising:
providing an event anomaly rule that defines a condition for requiring authorization for processing the event;
receiving an event notification for a user from a first data processing system;
receiving an availability notification from a mobile device associated with the user; and
sending the event notification to the mobile device associated with the user when the event satisfies the condition of the event anomaly rule at a time based on the availability notification.

17. The system of claim 16, wherein the operations further comprise;
receiving a processing authorization for the event from the mobile device associated with the user responsive to sending the event notification to the mobile device associated with the user; and
sending an instruction to a second data processing system associated with the user to process the event,

18. The system of claim 17, wherein the operations further comprise:
setting a timer responsive to sending the event notification to the mobile device associated with the user; and
wherein sending the instruction to the second data processing system comprises sending the instruction to the second data processing system when the processing authorization is received prior to expiration of the timer.

19. The system of claim 16, wherein the condition of the event anomaly rule is based on one of a date, a transaction description, and a monetary amount.

20. The system of claim 16, wherein the availability notification from the mobile device is based on use of a cellular interface on the mobile device, use of a Wi-Fi interface on the mobile device, use of a Bluetooth interface on the mobile device, and/or use of a wireless local area network (WLAN) interface on the mobile device.
